(19) United States
(12) Patent Application Publication
(10) Pub. No.: US 2018/0041375 A1
(43) Pub. Date: Feb. 8, 2018

(54) COMMUNICATION DEVICE, COMMUNICATION METHOD, AND COMPUTER READABLE MEDIUM

(71) Applicant: MITSUBISHI ELECTRIC CORPORATION, Tokyo (JP)

(72) Inventor: Kiyofumi TAKEUCHI, Tokyo (JP)

(73) Assignee: MITSUBISHI ELECTRIC CORPORATION, Tokyo (JP)

(21) Appl. No.: 15/549,079

(22) PCT Filed: Feb. 20, 2015
(86) PCT No.: PCT/JP2015/054791

§ 371 Date: Aug. 4, 2017

(51) Int. Cl. H04L 29/08; G06F 13/40

(52) U.S. Cl. CPC H04L 29/08954; G06F 13/4054; H04L 12/40019

(57) ABSTRACT

A communication device (100) to transmit a first communication frame and also transmit a second communication frame having a lower priority than a priority of transmitting the first communication frame includes a communication arbitration unit (107) to acquire, when a transmission request for the first communication frame has occurred during transmission of the second communication frame, an allowed time of a time required before a master device starts receiving the first communication frame, a remaining time until completion of the transmission of the second communication frame, and a necessary time required before the master device starts receiving the first communication frame, and determine whether to continue the transmission of the second communication frame on the basis of the allowed time, the remaining time, and the necessary time that have been acquired.

### TECHNICAL FIELD

The present invention relates to a communication device, a communication method, and a program. Particularly, the present invention relates to a communication device, a communication method, and a program that perform priority control when equipment connected to a network communicates.

### BACKGROUND ART

In a factory automation (FA) system, a control system is configured with one master device and a plurality of slave devices in many cases. Generally, the master device and each slave device perform communication over an FA control network, where the master device gives an instruction to each slave device, and the slave device executes the instruction to operate. Then, the slave devices transmit, to the master device, a response result and the like to the instruction.

The time taken for the instruction and the response transmitted and received between the master device and each slave device to make one cycle is called a cycle time.

When a highly accurate control is performed by utilizing motion control or the like, a cycle of performing communication is preset. The cycle of performing communication preset in this way is called a communication cycle. The master device and each slave device perform communication so as to complete the cycle time in a shorter time than this communication cycle.

Specifically, when the communication cycle is 200 us, an instruction from the master device to each slave and a response from each slave to the master are performed once every 200 us. Accordingly, the cycle time has to be less than 200 us.

As the FA network, there are a field network for field communication, a motion network for motion communication, and the like. The motion communication necessitates finer controls than the field communication, and in many cases, a shorter communication cycle is set.

The field communication and the motion communication may use different networks, but in some cases, the field communication and the motion communication are performed on a single network for the purpose of saving wiring.

In many cases, the communication cycle of the motion communication is shorter than that of the field communication.

In the FA network, when a slave device transmits a communication frame, the output of this communication frame may conflict with an output for relaying a communication frame transmitted from another slave device. Conceivably, priorities may be set in communication frames to prioritize the transmission of communication frames with high priority in order to solve this conflict.

By setting the field communication as low priority and the motion communication as high priority, the cycle time of the motion communication with a short communication cycle can be shortened in a network where the field communication and the motion communication coexist.

Patent Literature 1 discloses a control method for a case where communication frames having different priorities conflict in a slave device.

According to the method disclosed in Patent Literature 1, it is possible to replace a communication frame for failure notification with high-priority communication, and replace another communication frame with low-priority communication. According to the method of Patent Literature 1, when the transmission of the communication frame for failure notification occurs, even if another communication frame is being transmitted, the transmission is suspended and the communication frame for failure notification is transmitted first. Then, according to the method of Patent Literature 1, after the transmission of the communication frame for failure notification is completed, the other communication frame is transmitted again from the beginning.

### CITATION LIST

### Patent Literature

Patent Literature 1: WO 2013/111285 A

### SUMMARY OF INVENTION

### Technical Problem

The method disclosed in Patent Literature 1 can be considered an appropriate method as a method for transmitting a failure notification with the highest priority. However, in a network where the motion communication and the field communication coexist, it is not necessarily appropriate to apply the method of Patent Literature 1 to the high-priority motion communication.

In the motion communication, each slave device has to deliver a motion communication frame to the master device within a communication cycle. However, when a transmission request for a communication frame of the motion communication occurs while a communication frame of the field communication is being transmitted in the slave device, if the transmission of the communication frame of the field communication is suspended all the time, the efficiency of the field communication decreases. Accordingly, the method of Patent Literature 1 has an issue that it is not possible to satisfy a demand to perform the field communication as quickly as possible while prioritizing the motion communication in a network where the motion communication and the field communication coexist.

An object of the present invention is to provide a communication device capable of completing the field communication as quickly as possible while prioritizing the motion communication.

### Solution to Problem

A communication device according to the present invention transmits a first communication frame and also transmits a second communication frame having a lower priority than a priority of transmitting the first communication frame, and the communication device includes:

a communication arbitration unit to acquire, when a transmission request for the first communication frame has occurred during transmission of the second communication frame, an allowed time of a time required before a transmission destination device starts receiving the first communication frame, a remaining time until completion of the transmission of the second communication frame, and a necessary time required before the transmission destination device starts receiving the first communication frame, and determine whether to continue the transmission of the second communication frame on the basis of the allowed time, the remaining time, and the necessary time that have been acquired.

### Advantageous Effects of Invention

With the communication device according to the present invention, it is possible to control the priority so as to appropriately prioritize the transmission of the communication frame with high priority while not delaying the communication frame with low priority more than necessary. This is because the communication device according to the present invention includes a communication arbitration unit to acquire, when a transmission request for a first communication frame has occurred during the transmission of a second communication frame, an allowed time of a time required before a transmission destination device starts receiving the first communication frame, a remaining time until completion of the transmission of the second communication frame, and a necessary time required before the transmission destination device starts receiving the first communication frame, and determine whether to continue the transmission of the second communication frame on the basis of the allowed time, the remaining time, and the necessary time that have been acquired.

### BRIEF DESCRIPTION OF DRAWINGS

FIG. 1 is a diagram illustrating an example of a configuration of a network system according to a first embodiment.

FIG. 2 is a block configuration diagram of a communication device according to the first embodiment.

FIG. 3 is a diagram illustrating an example of a hardware configuration of the communication device according to the first embodiment.

FIG. 4 is a flow diagram illustrating a communication method and communication processing of the communication device according to the first embodiment.

FIG. 5 is a flow diagram illustrating priority determination processing of the communication device according to the first embodiment.

FIG. 6 is a diagram illustrating an example of a configuration of communication information according to the first embodiment.

FIG. 7 is a diagram illustrating an example of a configuration of communication information according to a second embodiment.

FIG. 8 is a flow diagram illustrating priority determination processing of a communication device according to the second embodiment.

### DESCRIPTION OF EMBODIMENTS

### First Embodiment

***Description of Configuration***

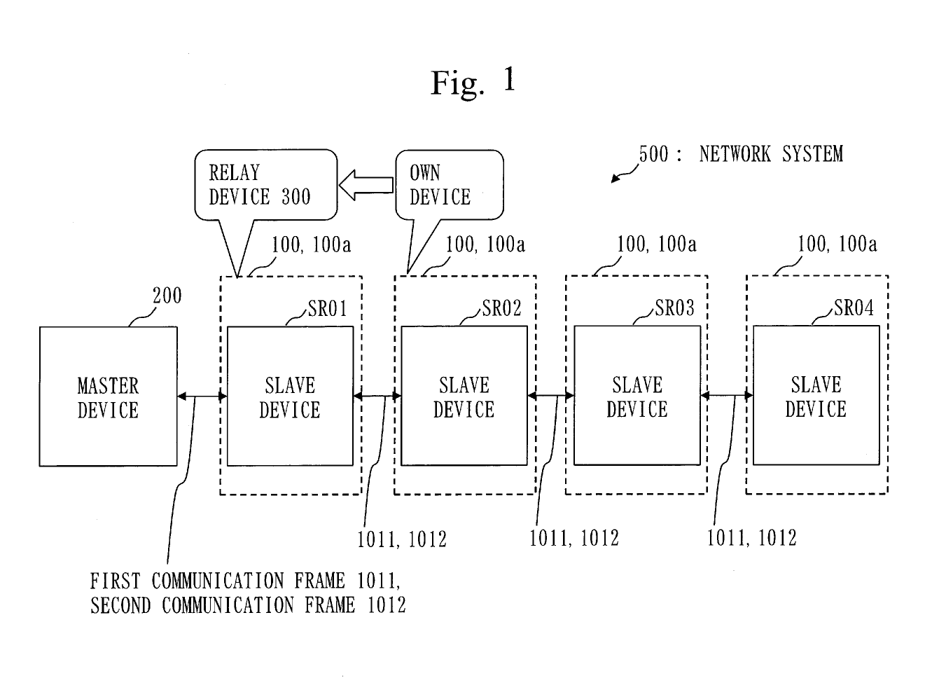

FIG. 1 is a diagram illustrating an example of a configuration of a network system 500 according to the present embodiment.

As illustrated in FIG. 1, the network system 500 is a line-type network and includes a master device 200 and a plurality of slave devices SR01, SR02, SR03, and SR04. Each of the slave devices is a communication device 100 according to the present embodiment.

That is, the communication devices 100 are slave devices which are connected to the network system 500 and communicate with the master device 200. Note that the network is not necessarily a line-type network, and the present embodiment can also be applied to networks with other topologies such as ring type, star type, and bus type.

The present embodiment assumes an FA network in which field communication and motion communication are performed on a single network for the purpose of saving wiring.

In the field communication, a field communication frame is transmitted and received. The field communication frame is an example of a second communication frame 1012.

In the motion communication, a motion communication frame having a higher priority than the priority of transmitting the field communication frame is transmitted and received. The motion communication frame is an example of a first communication frame 1011.

In the following description, the motion communication frame will be described as the first communication frame 1011 and the field communication frame as the second communication frame 1012.

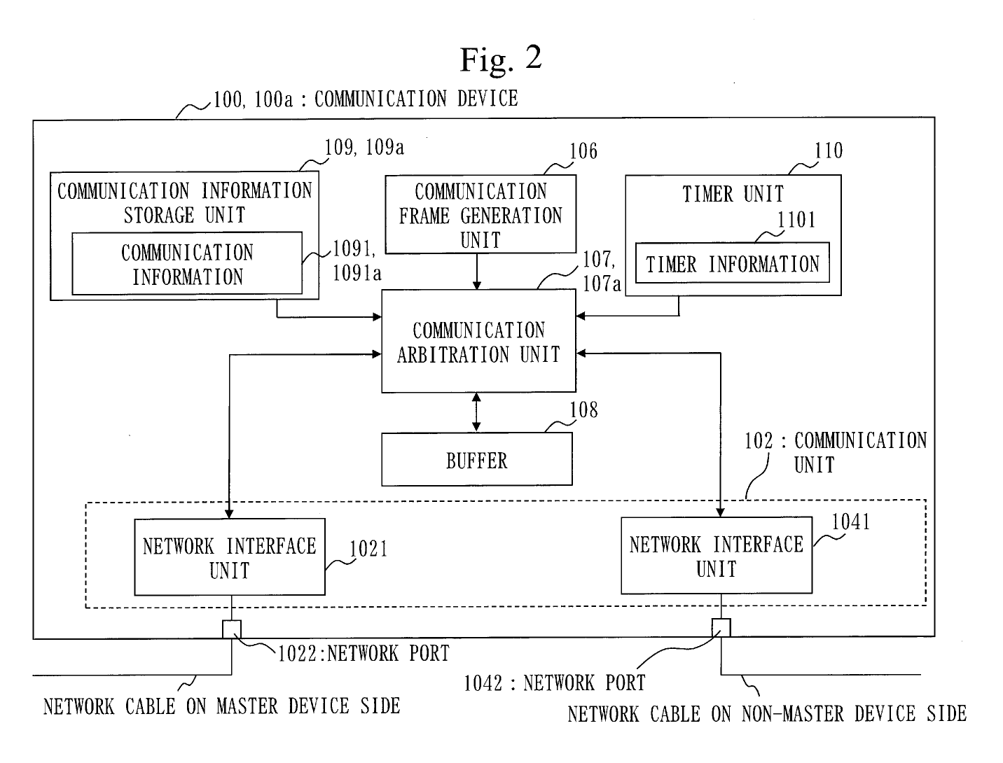

FIG. 2 is a block configuration diagram of the communication device 100 according to the present embodiment.

The communication device 100 transmits the first communication frame 1011 and also transmits the second communication frame 1012 having a lower priority than the priority of transmitting the first communication frame 1011.

The communication device 100 includes a communication unit 102, a communication frame generation unit 106, a communication arbitration unit 107, a buffer 108, a communication information storage unit 109, a timer unit 110, a network port 1022, and a network port 1042. The communication unit 102 includes a network interface unit 1021 and a network interface unit 1041.

The network interface unit 1021 transmits and receives communication frames to and from a network on the master device side via the network port 1022 and a network cable on the master device side.

The network interface unit 1041 transmits and receives communication frames to and from a network on the non-master device side via the network port 1042 and a network cable on the non-master device side.

The communication device 100 relays a communication frame received from one of the network ports to the other network port.

In addition, the communication device 100 transmits a communication frame generated by the communication frame generation unit 106 from the network port 1022 or the network port 1042.

The communication frame generation unit 106 generates communication frames. As the communication frames, there are the first communication frame 1011 with high priority and the second communication frame 1012 with low priority. The first communication frame 1011 is transmitted and received via the motion communication. The second communication frame 1012 is transmitted and received via the field communication.

When the communication device 100 is a slave device for performing the motion communication, the communication frame generated by the communication frame generation unit 106 of its own station is the motion communication frame, that is, the first communication frame 1011. In addition, when the communication device 100 is a slave device for performing the field communication, the communication frame generated by the communication frame generation unit 106 of its own station is the field communication frame, that is, the second communication frame 1012.

In the following description, the communication frame generated by the communication frame generation unit 106 will be described as a communication frame generated by its own station, and the communication frame received from one network port and relayed to the other network port will be described as a relay communication frame.

The communication arbitration unit 107 arbitrates between the communication frame generated by its own station and the relay communication frame.

The communication frame generated by its own station and the relay communication frame may be individually the first communication frame 1011 in some cases, and the second communication frame 1012 in other cases.

The communication information storage unit 109 stores communication information 1091. Configuration information of the network system 500 is set in the communication information 1091. The communication information 1091 is also referred to as network configuration information. In addition, the communication information storage unit 109 is also referred to as a network configuration information management unit that manages the network configuration information.

In the communication information 1091, a necessary time is preset. The necessary time is the time necessary for each of the other devices connected to the network system 500 to start receiving the communication frame that the communication device 100 starts transmitting. The details of the communication information 1091 will be described later.

The communication arbitration unit 107 determines whether a transmission request for the first communication frame 1011 has occurred during the transmission of the second communication frame 1012. When the transmission request for the first communication frame 1011 has occurred during the transmission of the second communication frame 1012, the communication arbitration unit 107 acquires an allowed time RT, a remaining time ST, and a necessary time NT.

The allowed time RT is an allowed time of a time required before a transmission destination device starts receiving the first communication frame 1011. The transmission destination device is the master device 200 or another communication device 100 other than the own device, that is, the communication device 100.

As described above, the motion communication frame, that is, the first communication frame 1011 needs to be transmitted from a transmission source device to the transmission destination device within kT1 which represents a communication cycle.

Therefore, the communication arbitration unit 107 calculates a time obtained by subtracting an elapsed time T2 from a communication time T1 as the allowed time RT. The elapsed time T2 is the time elapsed from a point of time at which the transmission source device starts transmitting the first communication frame 1011 to the current point of time.

The remaining time ST is the time that remains until completion of the transmission of the second communication frame 1012 being transmitted.

The necessary time NT is the time necessary for the transmission destination device to start receiving the first communication frame 1011.

The communication arbitration unit 107 determines whether to continue the transmission of the second communication frame 1012 on the basis of the allowed time RT, the remaining time ST, and the necessary time NT that have been acquired.

In some cases, while the communication arbitration unit 107 is transmitting a communication frame generated by its own station to the network on the master device side via the network interface unit 1021 and the network port 1022, a transmission request for transmission of a relay communication frame to the network on the master device side may occur. This relay communication frame is a communication frame that is received from the network port 1042 via the network interface unit 1041 and transmitted to the network on the master device side via the network interface unit 1021 and the network port 1022. In this case, the communication arbitration unit 107 determines which of the communication frames, i.e., the communication frame generated by its own station and the relay communication frame, is to be given transmission priority.

When the communication frame currently being transmitted is the motion communication frame, that is, the first communication frame 1011, the communication arbitration unit 107 transmits the communication frame subsequently requested for transmission after completing the transmission of the first communication frame 1011.

The buffer 108 stores communication frames that cannot be immediately transmitted upon transmission request, as in the case described above.

In addition, when the communication frame currently being transmitted is the field communication frame, that is, the second communication frame 1012, and the communication frame for which the transmission request is subsequently made is the motion communication frame, that is, the first communication frame 1011, the communication arbitration unit 107 determines which communication frame is given transmission priority.

The communication arbitration unit 107 calculates the time obtained by adding the remaining time ST and the necessary time NT as an addition time AT and compares the calculated addition time AT with the allowed time RT. When the allowed time RT is equal to or longer than the addition time AT, the communication arbitration unit 107 continues the transmission of the second communication frame 1012. Then, the communication arbitration unit 107 starts the transmission of the first communication frame 1011 after completing the transmission of the second communication frame 1012.

In addition, when the allowed time RT is shorter than the addition time AT, the communication arbitration unit 107 suspends the transmission of the second communication frame 1012. Then, the communication arbitration unit 107 starts transmitting the first communication frame 1011, and after completing the transmission of the first communication frame 1011, the communication arbitration unit 107 restarts transmitting the second communication frame 1012.

The communication arbitration unit 107 independently executes the determination processing described above in each of the transmission route from the communication arbitration unit 107 to the network interface unit 1021 and the transmission route from the communication arbitration unit 107 to the network interface unit 1041.

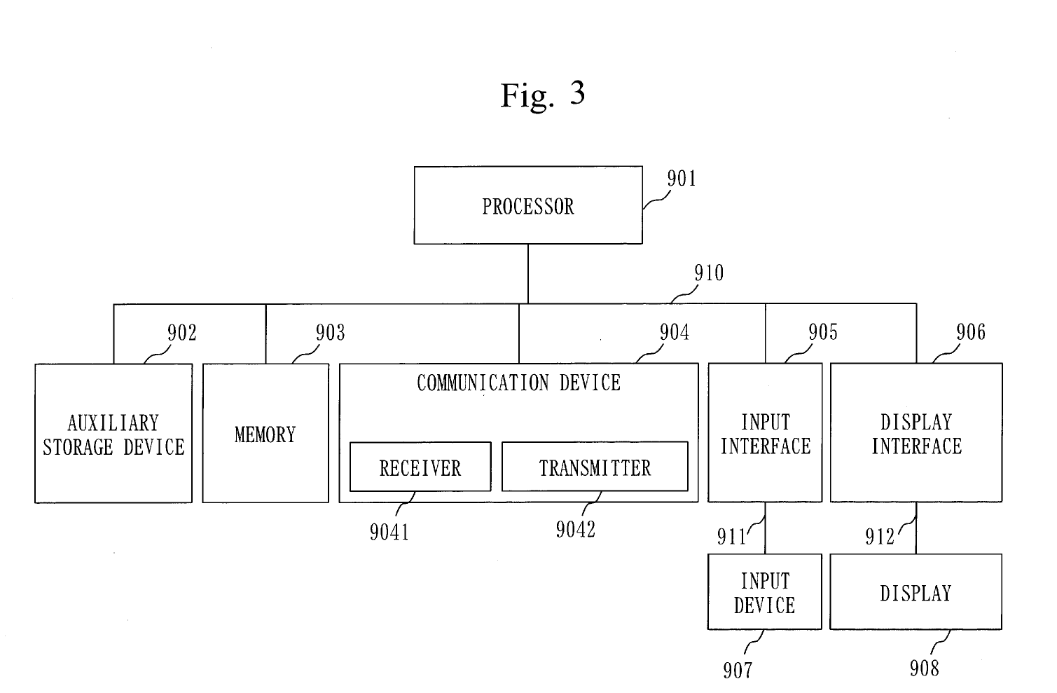

A description will be given of an example of a hardware configuration of the communication device 100 according to the present embodiment with reference to FIG. 3.

The communication device 100 is a computer.

The communication device 100 includes pieces of hardware such as a processor 901, an auxiliary storage device 902, a memory 903, a communication device 904, an input interface 905, and a display interface 906.

The processor 901 is connected to other pieces of hardware via a signal line 910 and controls these other pieces of hardware.

The input interface 905 is connected to an input device 907.

The display interface 906 is connected to a display 908.

The processor 901 is an integrated circuit (IC) that performs processing.

The processor 901 is, for example, a central processing unit (CPU), a digital signal processor (DSP), or a graphics processing unit (GPU).

The auxiliary storage device 902 is, for example, a read only memory (ROM), a flash memory, or a hard disk drive (HDD).

The memory 903 is, for example, a random access memory (RAM).

The communication device 904 includes a receiver 9041 that receives data and a transmitter 9042 that transmits data.

The communication device 904 is, for example, a communication chip or a network interface card (NIC).

The input interface 905 is a port to which a cable 911 of the input device 907 is connected.

The input interface 905 is, for example, a universal serial bus (USB) terminal.

The display interface 906 is a port to which a cable 912 of the display 908 is connected.

The display interface 906 is, for example, a USB terminal or a high definition multimedia interface (HDMI) (registered trademark) terminal.

The input device 907 is, for example, a mouse, a keyboard, or a touch panel.

The display 908 is, for example, a liquid crystal display (LCD).

The auxiliary storage device 902 stores a program for realizing the functions of the communication unit 102, the communication frame generation unit 106, and the communication arbitration unit 107 illustrated in FIG. 2. Hereinafter, the communication unit 102, the communication frame generation unit 106, and the communication arbitration unit 107 are collectively referred to as “unit”.

The program realizing the functions of the above-described “unit” is also referred to as a communication processing program. The program realizing the functions of the “unit” may be a single program or configured with a plurality of programs.

This program is loaded into the memory 903, read by the processor 901, and executed by the processor 901.

Furthermore, an operating system (OS) is also stored in the auxiliary storage device 902.

Then, at least part of the OS is loaded into the memory 903, and the processor 901 executes the program realizing the functions of the “unit” while executing the OS.

Although one processor 901 is illustrated in FIG. 3, the communication device 100 may include a plurality of processors 901.

Then, the plurality of processors 901 may execute the program realizing the functions of the “unit” in cooperation.

In addition, information, data, signal values, and variable values indicating the result of the processing of the “unit” are stored as a file in the memory 903, the auxiliary storage device 902, or a register or a cache memory in the processor 901.

The “unit” may be provided by a “circuitry”.

Furthermore, the “unit” may be replaced with a “circuit”, a “step”, a “procedure”, or “processing”. Furthermore, the “processing” may be replaced with the “circuit”, the “step”, the “procedure”, or the “unit”.

The “circuit” and the “circuitry” are concepts including not only the processor 901 but also other kinds of processing circuits such as a logic IC, a gate array (GA), an application specific integrated circuit (ASIC), or a field-programmable gate array (FPGA).

Note that what is referred to as a program product is a storage medium, a storage device, or the like in which the program realizing the functions described as the “unit” is recorded, and loads a computer-readable program regardless of the appearance form.

***Description of Operation***

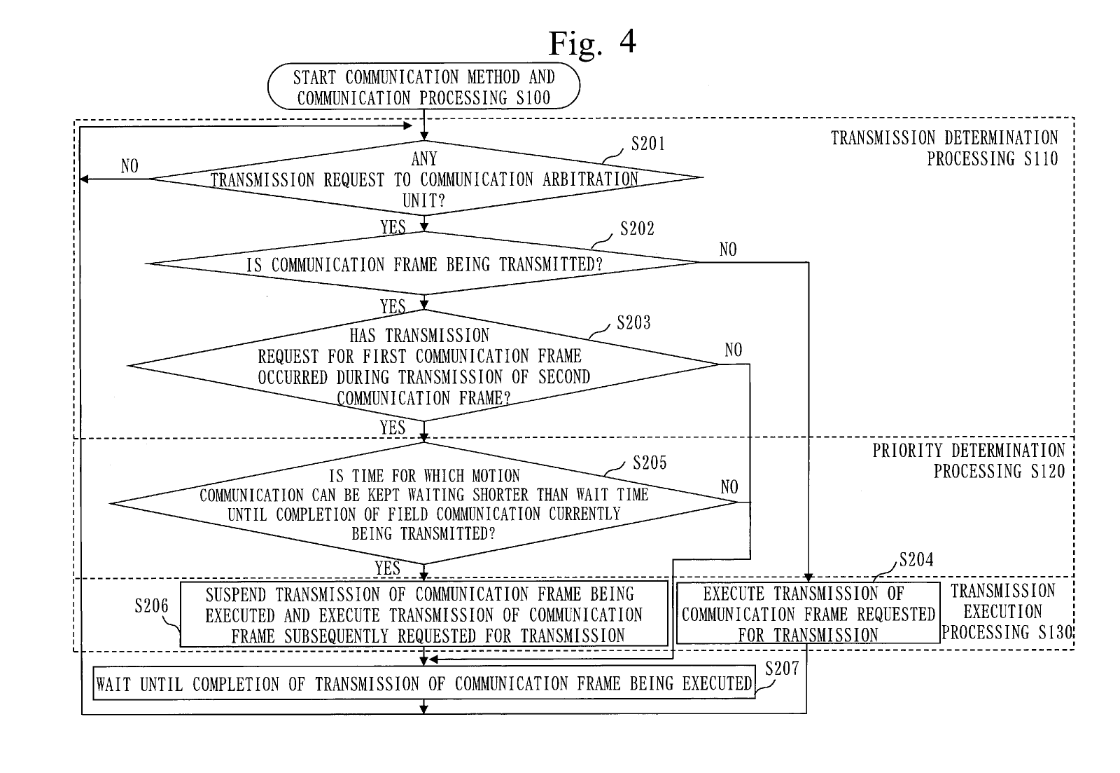

A description will be given of a communication method for the communication device 100 and communication processing S100 according to the present embodiment with reference to FIG. 4.

The communication device 100 transmits the first communication frame 1011 and also transmits the second communication frame 1012 having a lower priority than the priority of transmitting the first communication frame 1011.

<Transmission Determination Processing S110>

The communication arbitration unit 107 executes transmission determination processing S110 that determines whether a transmission request for the first communication frame 1011 has occurred during the transmission of the second communication frame 1012.

In S201, the communication arbitration unit 107 determines whether there is a transmission request to the communication arbitration unit 107.

In S201, when it is determined that there is a transmission request, processing proceeds to S202.

In S201, when it is determined that there is no transmission request, the processing in S201 is repeated until it is determined that there is a transmission request.

In S202, the communication arbitration unit 107 determines whether a communication frame is currently being transmitted.

In S202, when it is determined that there is a communication frame being transmitted, processing proceeds to S203.

In S202, when it is determined that there is no communication frame being transmitted, processing proceeds to S204.

In S203, the communication arbitration unit 107 determines whether the communication frame being transmitted is the second communication frame 1012 and the communication frame requested for transmission is the first communication frame 1011. In other words, the communication arbitration unit 107 checks whether a transmission request for the motion communication frame has occurred during the transmission of the field communication frame.

In S203, when it is determined that the transmission request for the first communication frame 1011 has occurred during the transmission of the second communication frame 1012, processing proceeds to S205.

In S203, when it is determined that the transmission request for the first communication frame 1011 has not occurred during the transmission of the second communication frame 1012, processing proceeds to S207.

<Priority Determination Processing S120>

As a result of the transmission determination processing S110, when it is determined that the transmission request for the first communication frame 1011 has occurred during the transmission of the second communication frame 1012, the communication arbitration unit 107 executes priority determination processing S120. The communication arbitration unit 107 acquires an allowed time RT of the time required before a transmission destination device starts receiving the first communication frame 1011, a remaining time ST until completion of the transmission of the second communication frame 1012, and a necessary time NT for the transmission destination device to start receiving the first communication frame 1011. The communication arbitration unit 107 executes the priority determination processing S120 that determines whether to continue the transmission of the second communication frame 1012 on the basis of the allowed time RT, the remaining time ST, and the necessary time NT that have been acquired.

In S205, the communication arbitration unit 107 checks whether the time for which the motion communication can be kept waiting is shorter than the wait time until completion of the field communication currently being transmitted.

The details of the priority determination processing S120 will be described later.

In S205, when it is determined that the time for which the motion communication can be kept waiting is shorter than the wait time until completion of the field communication currently being transmitted, processing proceeds to S206.

In S205, when it is determined that the time for which the motion communication can be kept waiting is not shorter than the wait time until completion of the field communication currently being transmitted, processing proceeds to S207.

<Transmission Execution Processing S130>

In S204, the communication arbitration unit 107 executes the transmission of the communication frame requested for transmission. That is, in S204, when there is a transmission request and there is no communication frame being transmitted, the communication arbitration unit 107 executes the transmission of the communication frame requested for transmission.

In S206, the communication arbitration unit 107 suspends the transmission of the communication frame being transmitted and executes the transmission of the communication frame subsequently requested for transmission.

When the transmission request for the first communication frame 1011 has occurred during the transmission of the second communication frame 1012, the communication arbitration unit 107 determines whether the first communication frame 1011 can be kept waiting until completion of the transmission of the second communication frame 1012.

Then, when it is determined that the first communication frame 1011 cannot be kept waiting, the communication arbitration unit 107 suspends the transmission of the second communication frame 1012 being transmitted, and executes the transmission of the first communication frame 1011 in S206.

In S207, the communication arbitration unit 107 waits until completion of the transmission of the communication frame being transmitted, and returns to S201 after completion of the transmission of the communication frame being transmitted.

Now, the description about the communication processing S100 of the communication device 100 according to the present embodiment will end.

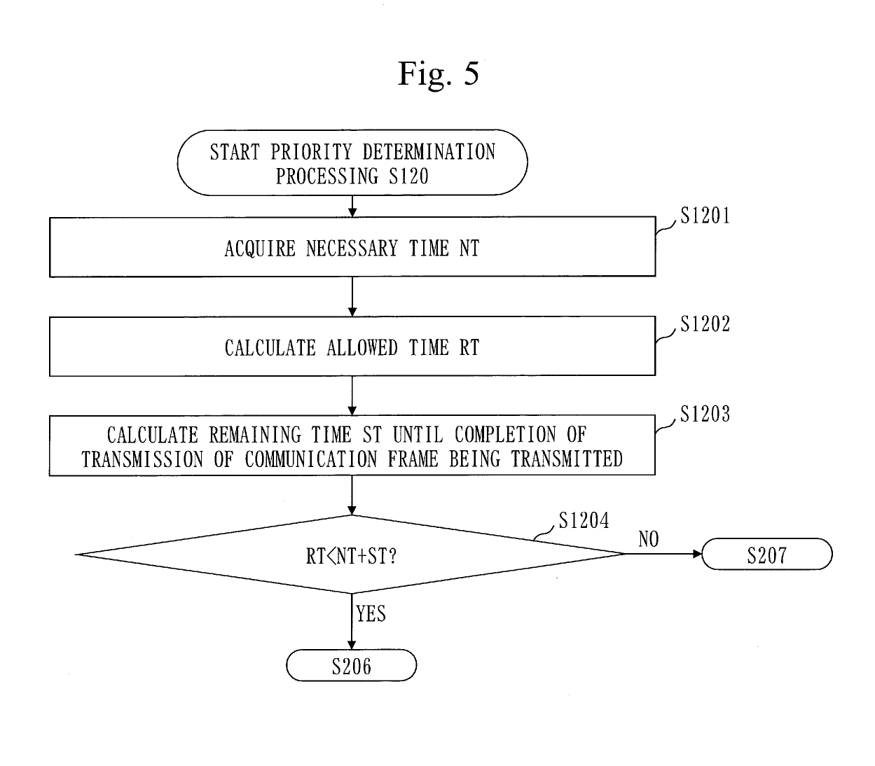

A description will be given of the priority determination processing S120 of the communication device 100 according to the present embodiment with reference to FIG. 5.

The communication arbitration unit 107 executes the priority determination processing S120 using the communication information 1091 and timer information 1101. The communication information 1091 is input from the communication information storage unit 109 into the communication arbitration unit 107. The timer information 1101 is input from the timer unit 110 into the communication arbitration unit 107.

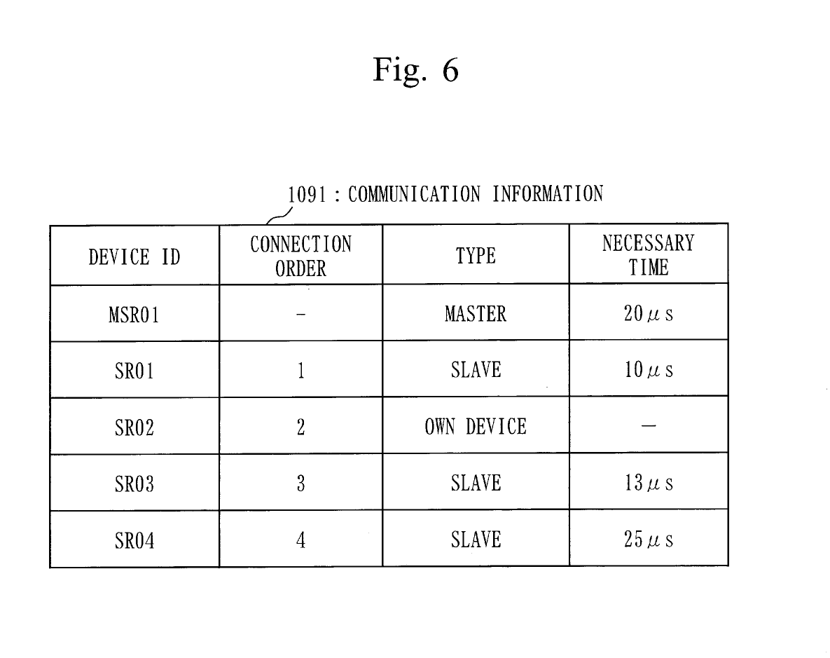

A description will be given of an example of the configuration of the communication information 1091 with reference to FIG. 6.

The communication information 1091 is information indicating how many slave devices are in between the master device 200 and the communication device 100 which is the slave device connected to the master device 200 via the network.

FIG. 6 illustrates an example of the communication information 1091 when the slave device SR02 illustrated in FIG. 1 is the communication device 100.

In the communication information 1091, a device ID uniquely indicating each device connected to the network system 500, a connection order of each device, a type of each device, and a necessary time for a communication frame to be received by each device are set.

In the device ID, MSR01 indicating the master device 200 as well as SR01, SR02, SR03, and SR04 indicating the respective slave devices are set.

In the connection order, what number each device is connected counting from the master device is set.

In the type, whether each device is a master, a slave, or its own device is set.

In the necessary time, a relay time for the communication frame to be delivered from the own device to each device is set. This is the time from when the communication device 100 starts transmitting the first one bit of the communication frame to when the first one bit of the communication frame is delivered to each device.

In a device initialization phase such as after device activation, the master device 200 measures the network relay time to each slave device and transmits the measurement result to each slave device. Each slave device sets the necessary time in the communication information 1091 on the basis of the measurement result transmitted from the master device 200. With the method as described above, the necessary time is set in the communication information 1091. In addition, without being limited to such a method, the communication information 1091 may be set by any other method.

In S1201, the communication arbitration unit 107 calculates a necessary time NT for the transmission destination device to start receiving the first one bit of the first communication frame 1011. Here, the communication arbitration unit 107 refers to the communication information 1091 to acquire the necessary time NT for the first one bit of the communication frame to be delivered to the master device 200. The master device 200 is the transmission destination device.

This will be described concretely with reference to FIG. 6. Using the communication information 1091, the communication arbitration unit 107 acquires the necessary time 20 μs from the own device to the master device 200 which is the transmission destination device.

In S1202, the communication arbitration unit 107 calculates an allowed time RT of the time required before the master device 200, which is the transmission destination device, starts receiving the first communication frame 1011. As described above, the motion communication frame, that is, the first communication frame 1011, needs to be transmitted from the transmission source device to the transmission destination device within the communication time T1 which represents the communication cycle. Therefore, the communication arbitration unit 107 calculates as the allowed time RT, a time obtained by subtracting an elapsed time T2 from the communication time T1. The elapsed time T2 is the time elapsed from a point of time at which the transmission source device starts transmitting the first communication frame 1011 to the current point of time.

In the first communication frame 1011, a communication start time at which the communication cycle has been started is set. The communication arbitration unit 107 acquires this communication start time from the first communication frame 1011. In addition, the communication arbitration unit 107 acquires the current time from the timer unit 110 as the timer information 1101. Using the communication start time and the current time that have been acquired, the communication arbitration unit 107 calculates the elapsed time T2 from the start of the motion communication cycle. Then, the communication arbitration unit 107 calculates the time obtained by subtracting the elapsed time T2 from the communication time T1 representing the communication cycle as the allowed time RT which is allowed as the remaining time of the communication cycle.

Note that the communication arbitration unit 107 may output the communication start time to the timer unit 110, and the timer unit 110 may calculate the allowed time RT.

In S1203, the communication arbitration unit 107 calculates a remaining time ST until completion of the transmission of the second communication frame 1012 being transmitted. For the second communication frame 1012 currently being transmitted, the communication arbitration unit 107 calculates the remaining time ST until completion of the transmission on the basis of the remaining data size to be transmitted.

Note that the order of the processing in S1201, S1202, and S1203 may not be necessarily as described above. As long as the necessary time NT, the allowed time RT, and the remaining time ST can be calculated, they may be calculated in any order.

In S1204, the communication arbitration unit 107 compares an addition time with the allowed time RT. The addition time is obtained by adding the remaining time ST and the necessary time NT.

When RT<NT+ST, the communication arbitration unit 107 determines that the time for which the motion communication can be kept waiting is shorter than the wait time until completion of the field communication currently being transmitted, and proceeds to S206. This is because if the motion communication is kept waiting, it becomes impossible to deliver the first communication frame 1011, which is the motion communication frame, to the master device 200 by the completion of the communication cycle of the current motion communication.

When not RT<NT+ST, that is, in the case of RT≧NT+ST, the communication arbitration unit 107 determines that the time for which the motion communication can be kept waiting is equal to or longer than the wait time until completion of the field communication currently being transmitted, and proceeds to S207. This is because even if the motion communication is kept waiting, the motion communication frame can be delivered to the master device 200 by the completion of the current communication cycle.

Now, the description about the priority determination processing S120 according to the present embodiment will end.

***Description of Effects***

With the communication device according to the present embodiment, priority control processing can be executed appropriately when a transmission request for communication with high priority has occurred during transmission of a communication frame with low priority in a network where communication frames with different priorities coexist. The communication device includes a function to determine whether to transmit the communication frame with high priority after completing the transmission of the communication frame with low priority, or cancel the transmission of the communication frame with low priority, transmit the communication frame with high priority, and subsequently re-execute the transmission of the communication frame with low priority, taking into account an allowed time until completion of arrival at a transmission destination.

Therefore, with the communication device according to the present embodiment, it is possible to control the priority so as to appropriately prioritize the transmission of the communication frame with high priority while not delaying the communication frame with low priority more than necessary. That is, the delay in the completion time of the field communication can be suppressed while the real-time performance of the motion communication can be ensured.

### Second Embodiment

The present embodiment will mainly describe differences from the first embodiment.

In the present embodiment, constituent parts having similar functions to the constituent parts described in the first embodiment are denoted by the same signs, and the description thereof may be omitted.

***Description of Configuration***

As illustrated in FIG. 1, for example, when the communication device 100 is the second slave device SR02 counting from the master device 200, a communication frame needs to pass through the slave device SR01 to reach the master device 200. Like this slave device SR01, a device that relays the communication frame is also referred to as a relay device 300.

The configuration of a communication device 100a according to the present embodiment is similar to the configuration of the communication device 100 in FIG. 2 described in the first embodiment.

In the present embodiment, a first communication frame 1011 is transmitted via the relay device 300 to the master device 200, which is the transmission destination device.

The communication device 100 includes a communication information storage unit 109a that stores communication information 1091a. The communication information 1091a includes a pass-through time T3 required for the relay device 300 to pass the first communication frame 1011.

A communication arbitration unit 107a calculates a time obtained by adding a remaining time ST, a necessary time NT, and the pass-through time T3 as an addition time AT, and executes priority determination processing S120a.

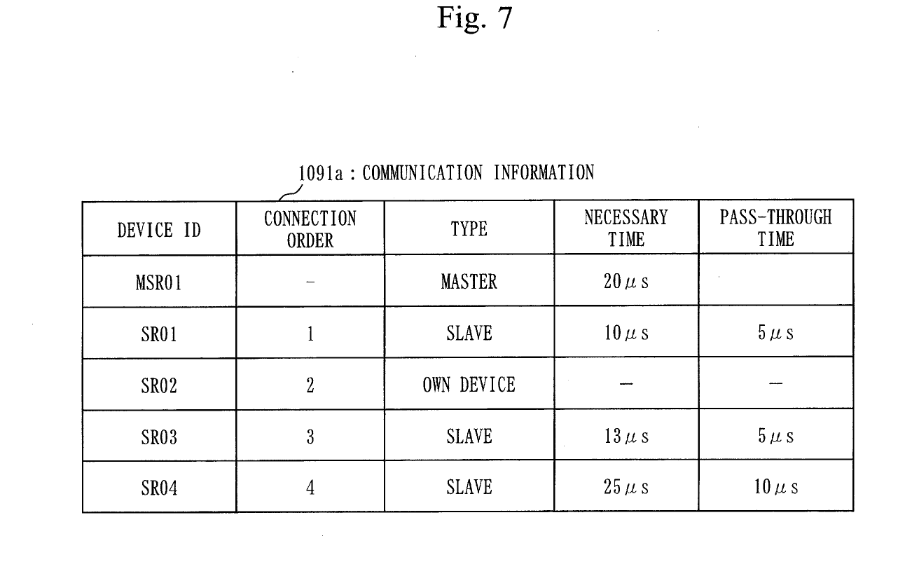

A description will be given of an example of a configuration of the communication information 1091a according to the present embodiment with reference to FIG. 7. FIG. 7 is a diagram corresponding to FIG. 6 described in the first embodiment.

The difference from FIG. 6 is that the pass-through time is set corresponding to each device.

The pass-through time is also referred to as a delay time required for each device to relay a communication frame.

Note that the communication arbitration unit 107a can find out how many slave devices or network switches are interposed between the communication device 100 and the master device 200 by referring to the communication information 1091a. Furthermore, the communication arbitration unit 107a can find out the pass-through time required for the device or the switch relaying the communication frame to relay the communication frame by referring to the communication information 1091a. In the communication information 1091a, the length of a network cable connecting between the devices or the switches as well as other information affecting the network relay time may be set.

***Description of Operation***

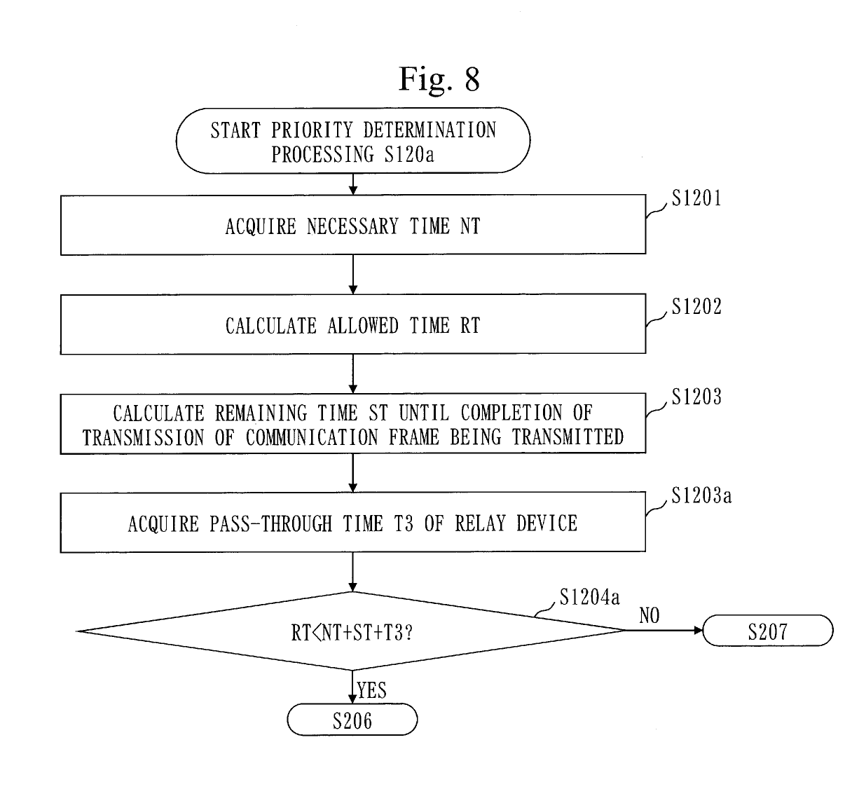

A description will be given of the priority determination processing S120a of the communication device 100a according to the present embodiment with reference to FIG. 8.

Processing in S1201, S1202, and S1203 are similar to that in the first embodiment.

In S1203a, the communication arbitration unit 107a acquires a pass-through time T3 of the relay device 300, through which the first communication frame 1011 passes until reaching the master device 200.

This will be described concretely with reference to FIG. 7. Using the communication information 1091a, the communication arbitration unit 107a acquires the pass-through time 5 μs of the slave device SR01, which is the relay device 300 through which the communication frame passes from the own device to the master device 200.

In S1204a, the communication arbitration unit 107a compares an addition time with an allowed time RT. The addition time is obtained by adding a remaining time ST, a necessary time NT, and the pass-through time T3.

When RT<NT+ST+T3, the communication arbitration unit 107a determines that the time for which the motion communication can be kept waiting is shorter than the wait time until completion of the field communication currently being transmitted, and proceeds to S206.

When not RT<NT+ST+T3, that is, in the case of RT≧NT+ST+T3, the communication arbitration unit 107 determines that the time for which the motion communication can be kept waiting is equal to or longer than the wait time until completion of the field communication currently being transmitted, and proceeds to S207.

Now, the description about the priority determination processing S120a according to the present embodiment will end.

Note that in many cases, the communication protocol of the motion network determines from which slave device the motion communication, which is from the slave device to the master device, is transmitted sequentially. In this case, how long the motion communication frame transmitted from the slave device to the master device can be kept waiting depends on the order of transmission to the master device.

For example, a description will be given of a case where there is a motion communication frame that needs to be delivered to the master at an earlier timing after the start of the communication cycle. In some cases, a slave device that has transmitted this motion communication frame and another slave device located between that slave device and the master device determine that there is some leeway until completion time of the communication cycle, and transmit this motion communication frame after the completion of the field communication. In such cases, it is conceivable that a motion communication frame to the master device, which is transmitted at a later time than this motion communication frame, may not make it in time by the finish time of the communication cycle.

Therefore, the time for which the motion communication can be kept waiting differs each time, depending on the transmission source of the motion communication frame requested for transmission.

Given such cases, the pass-through time set in the communication information 1091a preferably takes into account the order of the slave devices to determine the priority.

***Description of Effects***

With the communication device according to the present embodiment, in determining whether the cancellation of transmission of a communication frame with low priority is necessary, it is possible to calculate a delay time that arises along with communication between the own device and a transmission destination device under preset network configuration information, and use the delay time for the determination.

Furthermore, in determining whether the cancellation of transmission of a communication frame with low priority is necessary, it is possible to calculate, on the basis of transmission source information of a communication frame requested for transmission, a delay time that arises along with communication between the own device and a transmission destination device under preset network configuration information that differs depending on the communication frame, and use the delay time for the determination.

Therefore, with the communication device according to the present embodiment, it is possible to perform priority control with higher accuracy.

In the above-described embodiments, each of the network interface unit 1021, the network interface unit 1041, the communication frame generation unit 106, the communication arbitration unit 107, and the timer unit 110 constitutes the communication devices 100 and 100a as an independent functional block. However, the communication device may not necessarily be configured as described above, and the configuration of the communication device is arbitrary. The functional blocks of the communication device are arbitrary as long as they can realize the functions described in the above embodiments. The communication device may be configured with any other combination of these functional blocks, or any block configuration.

In addition, the communication device may not necessarily be a single device but may be a communication system including a plurality of devices.

In addition, although the first embodiment and the second embodiment have been described, parts of the plurality of embodiments among these two embodiments may be combined and implemented. Alternatively, among these two embodiments, one embodiment may be implemented partially. Still further, it is also possible that these two embodiments may be implemented wholly or partially with any combination thereof.

Note that the embodiments described above are preferred examples in nature and are not intended to limit the scope of the present invention, the applications, or uses thereof, and various modification can be made where necessary.

### REFERENCE SIGNS LIST

100, 100a: communication device, 102: communication unit, 106: communication frame generation unit, 107, 107a: communication arbitration unit, 108: buffer, 109, 109a: communication information storage unit, 110: timer unit, 200: master device, 300: relay device, 500: network system, 901: processor, 902: auxiliary storage device, 903: memory, 904: communication device, 905: input interface, 906: display interface, 907: input device, 908: display, 910: signal line, 911, 912: cable, 1011: first communication frame, 1012: second communication frame, 1021: network interface unit, 1041: network interface unit, 1022: network port, 1042: network port, 1091, 1091a: communication information, 1101: timer information, 9041: receiver, 9042: transmitter, AT: addition time, NT: necessary time, RT: allowed time, ST: remaining time, T1: communication time, T2: elapsed time, T3: pass-through time, SR01, SR02, SR03, SR04: slave device, S100: communication processing, S110: transmission determination processing, S120, S120a: priority determination processing, S130: transmission execution processing

1-7. (canceled)

8. A communication device to transmit a first communication frame and also transmit a second communication frame having a lower priority than a priority of transmitting the first communication frame, the communication device comprising:
processing circuitry to:
acquire, when a transmission request for the first communication frame has occurred during transmission of the second communication frame, an allowed time of a time required before a transmission destination device starts receiving the first communication frame, a remaining time until completion of the transmission of the second communication frame, and a necessary time required before the transmission destination device starts receiving the first communication frame, and determine whether to continue the transmission of the second communication frame on the basis of the allowed time, the remaining time, and the necessary time that have been acquired.

9. The communication device according to claim 8,
wherein the first communication frame is transmitted from a transmission source device to the transmission destination device within a communication time representing a communication cycle, and
the processing circuitry acquires, as the allowed time, a time obtained by subtracting, from the communication time, an elapsed time from a point of time at which the transmission source device starts transmitting the first communication frame to a current point of time.

10. The communication device according to claim 9,
wherein the processing circuitry calculates a time obtained by adding the remaining time and the necessary time as an addition time, and compares the calculated addition time with the allowed time, and
in a case where the allowed time is equal to or longer than the addition time, the processing circuitry continues transmitting the second communication frame and starts transmitting the first communication frame after completing the transmission of the second communication frame, and
in a case where the allowed time is shorter than the addition time, the processing circuitry suspends the transmission of the second communication frame, starts transmitting the first communication frame, and restarts transmitting the second communication frame after completing the transmission of the first communication frame.

11. The communication device according to claim 10,
wherein the first communication frame is transmitted to the transmission destination device via a relay device, and
the processing circuitry stores communication information including a pass-through time required for the relay device to pass the first communication frame, and
calculates, as the addition time, a time obtained by adding the remaining time, the necessary time, and the pass-through time.

12. The communication device according to claim 11,
wherein the communication information further includes the necessary time.

13. A communication method for a communication device to transmit a first communication frame and also transmit a second communication frame having a lower priority than a priority of transmitting the first communication frame, the communication method comprising:
determining whether a transmission request for the first communication frame has occurred during transmission of the second communication frame; and
acquiring when it is determined that the transmission request for the first communication frame has occurred during the transmission of the second communication frame, an allowed time of a time required before a transmission destination device starts receiving the first communication frame, a remaining time until completion of the transmission of the second communication frame; and a necessary time required before the transmission destination device starts receiving the first communication frame, and determining whether to continue the transmission of the second communication frame on the basis of the allowed time, the remaining time, and the necessary time that have been acquired.

14. A non-transitory computer readable medium storing a program of a communication device to transmit a first communication frame and also transmit a second communication frame having a lower priority than a priority of transmitting the first communication frame, the program causing a computer to execute:
transmission determination processing of determining whether a transmission request for the first communication frame has occurred during transmission of the second communication frame; and
priority determination processing of acquiring, when it is determined by the transmission determination processing that the transmission request for the first communication frame has occurred during the transmission of the second communication frame, an allowed time of a time required before a transmission destination device starts receiving the first communication frame, a remaining time until completion of the transmission of the second communication frame, and a necessary time required before the transmission destination device starts receiving the first communication frame, and determining whether to continue the transmission of the second communication frame on the basis of the allowed time, the remaining time, and the necessary time that have been acquired.
